(19) United States
(12) Patent Application Publication
(10) Pub. No.: US 2023/0157267 A1
(43) Pub. Date: May 25, 2023

(54) Tunable and adjustable swimbait

(71) Applicant: Christopher John Stephen Peterson, Folsom, CA (US)

(72) Inventor: Christopher John Stephen Peterson, Folsom, CA (US)

(21) Appl. No.: 17/300,840

(22) Filed: Nov. 22, 2021

(51) Int. Cl. A01K 85/16

(52) U.S. Cl. CPC A01K 85/16

(57) ABSTRACT

A tunable and adjustable swimbait that can accommodate different or various configurations, applications and parts may include a front portion; tail/rear portion or middle portion that is interchangeable and attaches to the front portion'

### BACKGROUND

Within the fishing industry, fishermen use swimbaits to attract and catch fish. There are various types of swimbaits that are used for the different types of applications or conditions that a fisherman might run into. Some of these would could include changing tides, the water current, location of the fish, weather conditions, and the different types of structure under the water. For these reasons, fishermen often need to buy different swimbaits for each of the different applications or conditions, which means buying multiple baits and ultimately spending more money.

So, therefore fishermen need a swimbait that is tunable and adjustable that can accommodate the various types of applications and different conditions.

### SUMMARY

The tunable and adjustable swimbait, is a like a One Stop Shop, where you have one bait and can accommodate all the various types of applications and conditions a fisherman might encounter. The swimbait includes a front portion, along with multiple interchangeable rear/tail portions that can attach to the front portion. A lip portion, located within the front portion where various types of lips (resin, weighted and/or diving lips) can be interchanged. Also, various numbers of the middle portion that is positioned between the front and rear/tail portions. Within the front portion is the optional weight chamber which houses weights that can be removed or inserted into the chambers. Each rear sections also have a chamber for a removable pin/screw.

### BRIEF DESCRIPTION OF THE FIGURES

FIGS. 1-7 represent each component of the Tunable and Adjustable Swimbait which will show the different views an/or configurations, parts and components.

### DETAILED DESCRIPTION OF THE FIGURES

Following, you will find a detailed description of the invention of the Tunable and Adjustable Swimbait. It must be noted, the following description and details only shows a few different configurations for this bait. This invention can be adapted into numerous different types of configurations that are not show in the following illustrations and descriptions. Also, there are elements and/or parts that may be substituted and used to design this swimbait that will not change the function or operation of this bait.

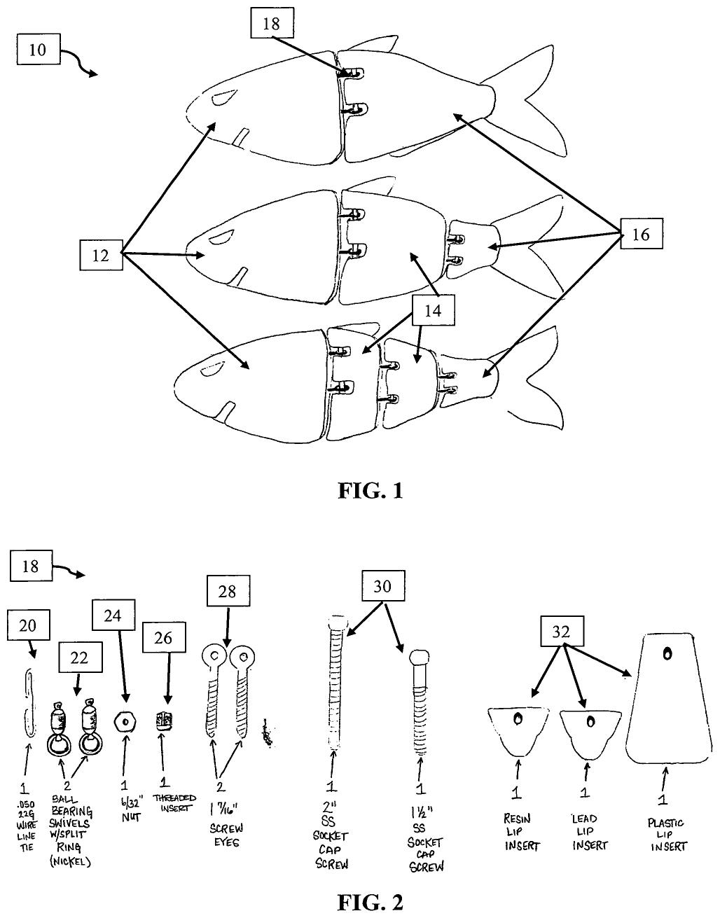

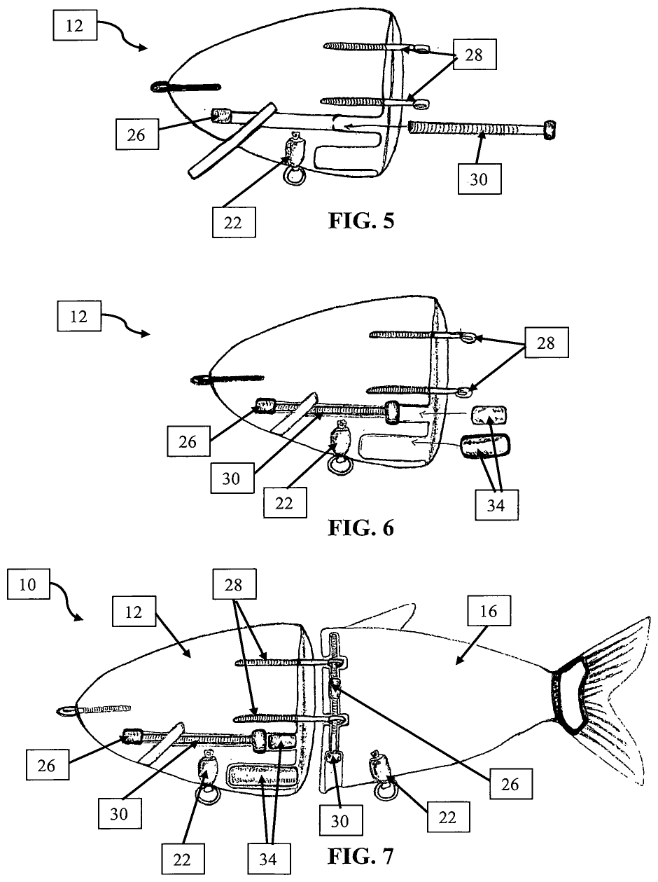

FIGS. 1-7 will show the different portions of the Tunable and Adjustable Swimbait 10. The swimbait 10 is comprised of a front/head portion 12; rear/tail portions 16 which can be and attached to the front portion 12. The front portion 12 and the various rear sections are attached to each other by the removable locking screw/pin 18. The rear/tail portions can be made up of segments 14, which are attached to each other and can be interchanged and attached to the front/head portion 12 using the removable locking pin/screw 18. Within the front/head portion there is an area 31 where you can insert various types of lips 32 (ie., resin, weighted lead or diving lips). Also, within the front portion/head 12 you will find one to two chambers 34, that hold optional weights and the screw 30 for the interchangeable lips 32. The removable locking screw/pin that holds the front section 12 and the various rear/tail and/or middle sections 14 & 16 together, is designed to allow those rear/tail & middle 14 & 16 portions and/or sections to swivel, sway, swing and/or rotate in a back and forth motion.

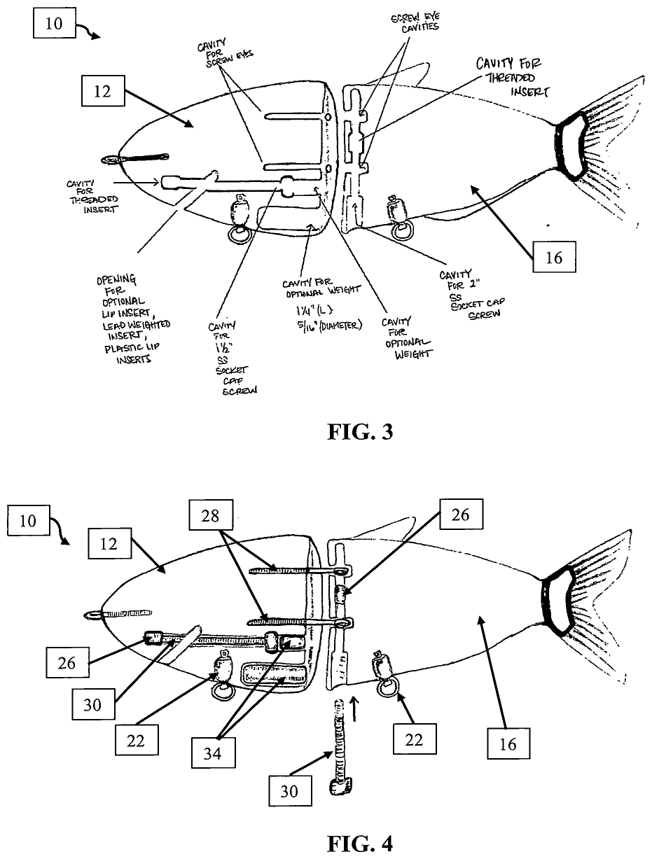

As you will see in the Figures, the front portion 12, is made to resemble the head of a fish. The front portion 12 is comprised of multiple chambers and/or cavities that can accommodate a locking screw and/or pin 30 for the interchangeable lips 32. Also it has pair of cavities that accommodate components that make up a portion of the locking system 18. Those pair of cavities are sized to accommodate a treaded portion of a screw eye 28. The threaded portion of the screw eye 28 is located within the front portion 12. When inserted within the front portion 12, the screw eyes run parallel with the top of the front portion 12. The rounded portion of the screw eye 28, that has the hole is located on the outside of rear of the front portion 12 and extends out in the direction of the middle portion 14 or rear portion 16. The two other chambers and or cavities house a socket cap screw 30 which at the end has a threaded insert 26 and holds the interchangeable lips 32. Located at the end of the chambers and/or cavities, closest to the rear/tail portion 16 and/or middle portions 14 is where the interchangeable weights 34 are held, see FIG. 3 and also FIG. 4. The optional lip inserts 32 are placed within the lip insert cavity. When the lip insert 32 is inserted into the lip insert cavity, the hole in the lip insert 32 will align with the hole for the socket cap screw 30 so that the socket cap screw 30 will pass thru the lip insert 32 and grab and lock into the threaded insert 26. The socket cap screw 30 passes thru the lip insert 32 and into the threaded insert 26 so that it locks the interchangeable lip 32 into place. The front portion 12 is also comprised of a ball bearing swivel 22 that is partially inserted within the bottom portion of the front portion 12. The chambers and/or cavities of which house the screw eyes 28, socket cap screw 30, and option weights 34 are parallel to each other. The front portion 12 may have a wire line tie 20, which a portion extends outward from the front portion and the other portion is located within the front portion 12.

Shown in FIG. 3, the rear/tail portion 16 is made to resemble the tail of a fish. Within the rear/tail portion 16 and also within the front portion of the middle portion 14 there is a chamber/cavity for a socket cap screw 30 that runs perpendicular. Also, located in the front section of the rear/tail portion 16 and the middle portion 14 are two screw eye cavities in which the socket cap screw 30 threads itself thru. Within the socket cap screw threaded cavity is a nut 24 in which the socket cap screw 30 is threaded thru when screwing it in. The screw eye cavities are perpendicular to the socket cap screw cavity. The various rear/tail portion 16 and middle portion 14 are attached to the front portion 12, when the front portion 12 screw eyes 28 are placed within the screw eye cavities in the rear/tail portion 16 and/or middle portion 14 so that it's aligned with the holes for the socket cap screw 30 and the socket cap screw is screwed into the socket cap screw cavity. As the socket cap screw 30 makes its way up thru the socket cap screw threaded cavity, it enters in the first screw eye cavity, then thru the first screw eye 28, then thru the nut 24, it then enters the second or top screw eye cavity, thru the next screw eye 28 and then slightly into the top portion of the tail/rear portion 16 or middle portion 14. This design of attaching the front portion 12 and the rear/tail portion 16 or middle portion 14 is designed specifically to allow the tail/rear portion 16 or middle portion 14 to swivel, sway, swing and/or rotate in a back and forth motion. Also, the optional weights 34 that are located in the front portion 12, when inserted and not secured in place, allows the weights 34 to come in contact with the front of the rear/tail portion 16 or middle portion 14. As the rear/tail portion 16 or middle portion 14 swings back and forth in the water, the optional weight 34 bounces off of the rear/tail portion 16 or middle portion 14 which creates momentum to help the rear/tail portion 16 and middle portion 14 to swivel, sway, swing, and/or rotate in a back and forth, side to side motion as the swimbait is reeled in. The tail/rear portion 16 or middle portion 14 is comprised of a ball bearing swivel 22, that is partially inserted into the belly or bottom of the rear/tail portion 16 and middle portion 14. It should be noted that a locking pin or any other such locking pin or screw can be used in place of the socket cap screw 30 to attach the front portion 12 and the rear/tail portion 16 or middle portion 14. Also, a use of a magnet could be used to attach the front portion 12 and the rear/tail portion 16 or middle portion 14.

As explained above with the attaching of the front portion 12 to the rear/tail portion 16. The middle portion 14 may also be attached the same way.

For use of the swimbait 10, you would take the front portion 12, a rear/tail portion 16 or a middle portion 14 and attach the front portion 12 to either the rear/tail portion 16 or middle portion 14 by inserting the screw eyes 28 that are located in the front portion 12 into the screw eye cavities that are located in the front section of the rear/tail portion 16 and/or middle portion 14. The socket cap screw 30 is inserted into the socket cap screw threaded cavity that is located in the rear/tail portion 16 or middle portion 14. As the socket cap screw 30 makes its way up thru the socket cap screw threaded cavity, it enters in the first screw eye cavity, then thru the first screw eye 28, then thru the nut 24, it then enters the second or top screw eye cavity, thru the next screw eye 28 and then slightly into the top portion of the tail/rear portion 16 or middle portion 14. To change to change out the rear/tail portion 16 or middle portion 14, simply remove the socket cap screw, attach the desired rear/tail portion 16 or middle portion 14 and attach in a similar manner. If you would like to remove or add the optional weights 34, remove the attached rear/tail portion 16 or middle portion 14 as stated above and remove or add optional weights 34 from the weight cavities. Changing the weights gives the ability the change how the swimbait 10 swims. It can swim on top of the water or near the top with little or no weight and lower or deeper in the water with more weight.

Also, the swimbait has an interchangeable lips 32 which is located in the front portion 12. Lips can be made of resin, lead or plastic. To change the interchangeable lips 32 take the front portion 12 which has been separated from the rear/tail portion 16 or middle portion 14. Remove the socket cap screw 30 which is a threaded cavity that is located at the of the option weight chamber where the option weights 34 are placed. Once the socket cap screw 30 is removed, add the desired lip insert 32, insert the socket cap screw 30 back into the option weight chamber and screw it in making sure that it goes the hole of the desired optional lip insert 32 and into the threaded insert 26 that is located at the end of the option weight chamber. If you want to change to a different lip insert 32, repeat the steps above.

The description of the Tunable and Adjustable swimbait is not limited to just to the above details it can made with different parts, but that does not change the design of the invention or how it works or functions.

What is claimed:

1. A tunable and adjustable swimbait that can accommodate different or various types of applications, configurations, parts which is comprised of:
a front portion;
a tail/rear portion which attached interchangeably to the front portion;
an optional middle portion;
an interchangeable diving lip insert which can be inserted into the front portion;
at least one optional weight or weights that can be inserted or removed into the weight chamber located within the front or rear portions; and
a fastening system that attaches the front portion and rear/tail portion or middle portion by a removable screw, pin, magnet or any other part that can fasten the two sections together securely.
